(19) United States
(12) Patent Application Publication
(10) Pub. No.: US 2021/0301723 A1
(43) Pub. Date: Sep. 30, 2021

(54) Gas Turbine Combustor and Fuel Nozzle Manufacturing Method

(71) Applicant: Mitsubishi Power, Ltd., Yokohama-shi (JP)

(72) Inventors: Satoshi KUMAGAI, Tokyo (JP); Kota NAGANO, Tokyo (JP); Atsuo OTA, Yokohama-shi (JP)

(21) Appl. No.: 17/146,713

(22) Filed: Jan. 12, 2021

(30) Foreign Application Priority Data
Mar. 31, 2020 (JP) 2020-061684

(51) Int. Cl. F02C 7/232; F23R 3/28; B33Y 80/00; B33Y 10/00; B22F 10/28

(52) U.S. Cl. CPC F02C 7/232; F23R 3/28; B33Y 80/00; F05D 2240/36; B22F 10/28; F05D 2220/32; F05D 2230/31; B33Y 10/00

(57) ABSTRACT

There is provided a gas turbine combustor which includes a fuel nozzle which is high in damping performance against vibration stress caused by unstable combustion, in the gas turbine combustor which includes the fuel nozzle which is molded by 3D additive manufacturing. In the gas turbine combustor which includes the fuel nozzle which is molded by the 3D additive manufacturing, the fuel nozzle has a first region on which metal powders are sintered and a second region which is surrounded by the first region and on which the metal powders are not sintered.

### CLAIM OF PRIORITY

The present application claims priority from Japanese Patent application serial no. 2020-061684, filed on Mar. 31, 2020, the content of which is hereby incorporated by reference into this application.

### BACKGROUND OF THE INVENTION

The present invention pertains to a structure of a gas turbine combustor and a method of manufacturing the gas turbine combustor and, in particular, relates to a technology which is effectively applied to a structure and a manufacturing method for a fuel nozzle which is manufactured by a metal 3D additive manufacturing technology.

In a gas turbine, strict environmental standards are set on NOx which is exhausted in operation of the gas turbine for reducing a load that exhaust gas exerts on the environment. Since the exhaust amount of NOx is increased with the increasing temperature of flames, it is necessary to locally suppress formation of the high-temperature flames and thereby to realize uniform combustion. A complicated burner structure which realizes high dispersiveness of fuel becomes necessary for attaining the uniform combustion of the fuel.

A 3D additive manufacturing technology is proposed as measures for manufacturing the complicated burner structure. According to the 3D additive manufacturing technology, it becomes possible to manufacture a complicated structure by irradiating metal powders with laser and thereby sintering the metal powders. It is possible to realize the complicated structure which leads to improvement of dispersiveness of the fuel by applying the 3D additive manufacturing technology to manufacture of the burner structure (component).

Although the improvement of dispersiveness of the fuel contributes to reduction of NOx emissions, there is the possibility that unstable combustion may temporarily occur depending on an operation condition of the combustor. There is the possibility that pressure fluctuation may occur in a combustion space due to the unstable combustion and thereby a component may be damaged. It is necessary to adopt a structure which would withstand a temporary increase in pressure fluctuation in order to avoid such damage of the component.

As a background art in the present technical field, there exists a technology such as that which is disclosed in, for example, Japanese Unexamined Patent Application Publication No. 2007-205351. In Japanese Unexamined Patent Application Publication No. 2007-205351, “in airfoils for use in a gas turbine engine, one airfoil for use in the gas turbine engine which includes a cellular material which is disposed in a cavity so as to make it possible to define the cavity and to reinforce the airfoil and is distributed throughout the entire cavity as well as a vibration damping medium which is disposed in the cavity so as to make it possible to damp the vibration of the airfoil and is allotted throughout the entire cellular material in the cavity” is disclosed.

### SUMMARY OF THE INVENTION

As described above, it is possible to realize a complicated structure which leads to the improvement of dispersiveness of the fuel by 3D lamination. On the other hand, it is necessary to adopt a structure which would withstand the temporary increase in pressure fluctuation caused by the unstable combustion.

In general, vibration stress which generates in association with the pressure fluctuation reaches maximum on a root of the fuel nozzle. As one of methods of reducing the vibration stress, there is a method of increasing the diameter of the root of the fuel nozzle. Although this method has such an effect that a section modulus is increased owing to an increase in root diameter and thereby the vibration stress is reduced, this effect is limited to a case where there exists a spatial margin which is sufficient to increase the root diameter.

As another method, there is a method of improving the damping performance of the fuel nozzle and thereby reducing the vibration stress. This method makes it possible to reduce the vibration stress by incorporating a structure which improves the damping performance by utilizing the 3D additive manufacturing into the fuel nozzle without changing the shape of the fuel nozzle.

The vibration of the airfoil is damped by disposing the vibration damping medium throughout the inside of the cavity in Japanese Unexamined Patent Application Publication No. 2007-205351. However, nothing is referred to the problem of the vibration stress on the root of the fuel nozzle and the improvement of the damping performance by the 3D additive manufacturing such as those described above.

Accordingly, the present invention aims to provide a gas turbine combustor which includes a fuel nozzle which is high in damping performance against the vibration stress caused by the unstable combustion, in the gas turbine combustor which includes the fuel nozzle which is molded by the 3D additive manufacturing.

In addition, the present invention also aims to provide a fuel nozzle manufacturing method which makes it possible to manufacture the fuel nozzle which is high in damping performance against the vibration stress caused by the unstable combustion, in the method of manufacturing the fuel nozzle by the 3D additive manufacturing.

In order to solve the abovementioned problems, according to one aspect of the present invention, there is provided a gas turbine combustor including a fuel nozzle which is molded by 3D additive manufacturing, in which the fuel nozzle has a first region on which metal powders are sintered and a second region which is surrounded by the first region and on which the metal powders are not sintered.

In addition, according to another aspect of the present invention, there is provided a method of manufacturing a fuel nozzle by metal 3D additive manufacturing, including the steps of (a) irradiating a first region of a face which is molded by the metal 3D additive manufacturing with laser and sintering metal powders onto the first region and (b) leaving non-sintered metal powders on a second region which is surrounded by the first region of the molded face with no irradiation of the second region with laser.

According to the present invention, it becomes possible to realize the gas turbine combustor which includes the fuel nozzle which is high in damping performance against the vibration stress caused by the unstable combustion, in the gas turbine combustor which includes the fuel nozzle which is molded by the 3D additive manufacturing.

In addition, it becomes also possible to realize the fuel nozzle manufacturing method which makes it possible to manufacture the fuel nozzle which is high in damping performance against the vibration stress caused by the unstable combustion, in the method of manufacturing the fuel nozzle by the 3D additive manufacturing.

Accordingly, it becomes possible to provide the gas turbine combustor which has sufficient structure reliability for an increase in pressure fluctuation caused by the unstable combustion.

Problems, configurations and effects other than the above will become apparent from the following description of embodiments.

### BRIEF DESCRIPTION OF THE DRAWINGS

FIG. 1. is a sectional diagram illustrating one example of a schematic configuration of a gas turbine combustor according to one embodiment of the present invention;

FIG. 2 is an enlarged diagram illustrating one example of a burner 17 in FIG. 1;

FIG. 3 is a diagram illustrating one example of a damping effect of a component structure which contains non-sintered metal powders therein;

FIG. 4 is a sectional diagram illustrating one example of a fuel nozzle according to a first embodiment of the present invention;

FIG. 5 is an enlarged diagram illustrating one example of a leading end of the fuel nozzle in FIG. 4;

FIG. 6 is a sectional diagram illustrating one example of a fuel nozzle according to a second embodiment of the present invention;

FIG. 7 a sectional diagram illustrating one example of a fuel nozzle according to a third embodiment of the present invention;

FIG. 8 is a sectional diagram illustrating one example of a fuel nozzle according to a fourth embodiment of the present invention;

FIG. 9 is a sectional diagram illustrating one example of a fuel nozzle according to a fifth embodiment of the present invention; and

FIG. 10 is a sectional diagram illustrating one example of a method of manufacturing a fuel nozzle according to a sixth embodiment of the present invention.

### DETAILED DESCRIPTION OF THE PREFERRED EMBODIMENTS

In the following, embodiments of the present invention will be described with reference to the appended drawings. Incidentally, the same numerals are assigned to the constitutional elements having the same configurations and detailed description of duplicated parts is omitted.

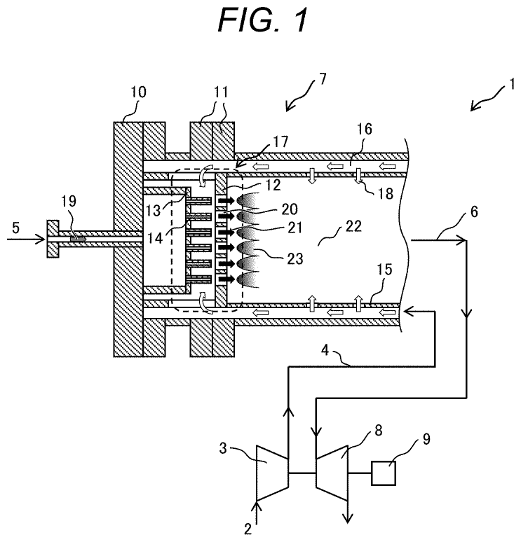

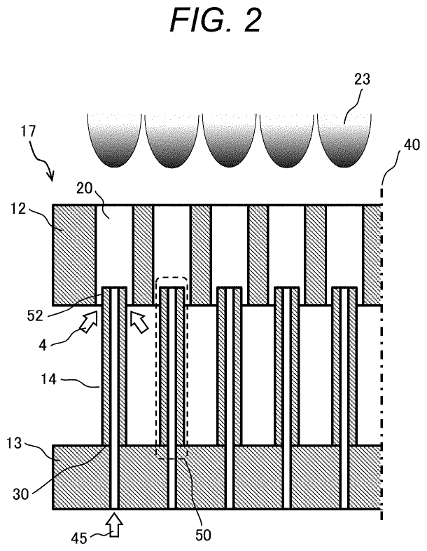

First, a gas turbine combustor which becomes the subject of the present invention will be described with reference to FIG. 1 and FIG. 2. FIG. 1 is a sectional diagram illustrating one example of a schematic configuration of a gas turbine combustor according to one embodiment of the present invention. In FIG. 1, the gas turbine combustor is illustrated as a gas turbine plant 1 which includes a compressor 3, a gas turbine 8 and a generator 9. FIG. 2 is an enlarged diagram illustrating one example of a burner 17 in FIG. 1.

As illustrated in FIG. 1, the gas turbine plant 1 includes the compressor 3 which takes in air 2 from the atmosphere and compresses the air 2, a combustor 7 which mixes compressed air 4 which is compressed in the compressor 3 with fuel 5, burns the fuel 5 with the compressed air 3 and generates a high-temperature and high-pressure combustion gas 6, the gas turbine 8 which is driven with the combustion gas 6 which is generated in the combustor 7 and takes out energy of the combustion gas 6 as rotational power, and the generator 9 which generates electricity by using the rotational power of the gas turbine 8.

In FIG. 1, a structure which includes an end flange 10, an external cylinder 11, a perforated plate 12, a fuel nozzle plate 13, fuel nozzles 14 and a liner 15 is illustrated in FIG. 1 as one example of the combustor 7.

However, the present invention is also applicable to combustors of various structures, not limited to the combustor 7 in FIG. 1.

The compressed air 4 which is compressed by the compressor 3 passes through a flow path 16 which is formed between the external cylinder 11 and the liner 15 and flows into the burner 17. Part of the compressed air 4 flows into the liner 15 as cooling air 18 for cooling the liner 15.

The fuel 5 passes through a fuel feed pipe 19 in an end flange 10, flows into the fuel nozzle plate 13, passes through the respective fuel nozzles 14, and is injected to the perforated plate 12. The fuel 5 which is injected from the fuel nozzles 14 and the compressed air 4 are mixed together at fuel-nozzle-side inlet ports of nozzle holes 20 in the perforated plate 12, and an air-fuel mixture 21 of the fuel 5 and the compressed air 4 is injected toward a combustion chamber 22 and forms flames 23.

Incidentally, it is possible for the combustor 7 according to the present invention to use fuels such as coke oven gas, refinery off-gas, coal gasified gas, and so forth, not limited to natural gas.

FIG. 2 is an enlarged diagram illustrating one example of the burner 17 in FIG. 1. FIG. 2 illustrates the enlarged diagram of an upper half part of the burner 17. The burner 17 includes the perforated plate 12, the fuel nozzle plate 13, and the fuel nozzles 14. Central axes 40 of the perforated plate 12 and the fuel nozzle plate 13 match each other. An upstream-side end 30 of each fuel nozzle 14 is metallurgically bonded to the fuel nozzle plate 13 and a bonded part between the upstream-side end 30 and the fuel nozzle plate 13 is sealed so as to avoid leakage of the fuel 5 (45).

A leading end 52 of each fuel nozzle is not in contact with each nozzle hole 20 in the perforated plate 12 and therefore it is possible for the compressed air 4 to freely flow into the nozzle holes 20. In general, welding, brazing and so forth are utilized as a method of bonding the upstream-side ends 30 of the fuel nozzles 14 to the fuel nozzle plate 13.

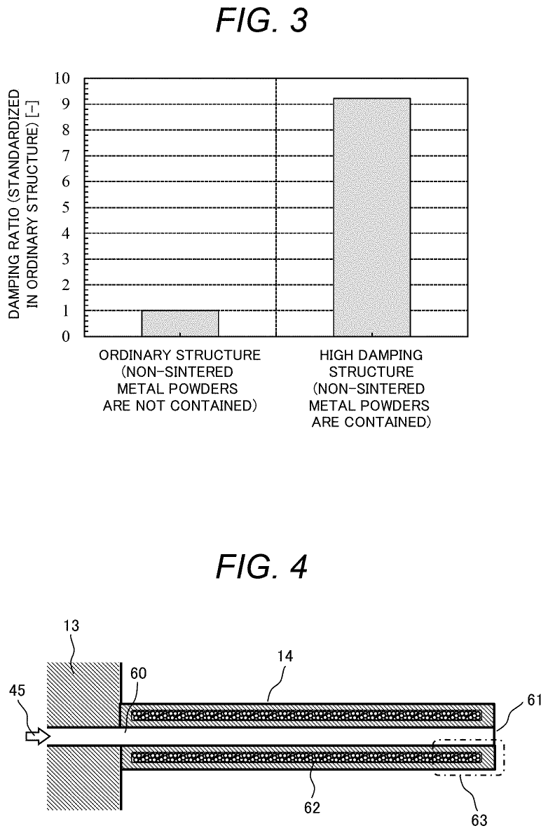

Next, an effect of improving the damping performance against the vibration stress of the component which contains the non-sintered metal powders will be described with reference to FIG. 3.

FIG. 3 indicates one example of a damping ratio of a cylindrical cantilever which is manufactured by the 3D additive manufacturing. An ordinary structure whose damping ratio is plotted on a left-side graph is a hollow structure which contains no non-sintered metal powders therein and a high-damping structure whose damping ratio is plotted on a right-side graph contains the non-sintered metal powders therein. The damping ratio is improved by about nine times by leaving the non-sintered metal powders in the component and thereby the effect of damping the vibration is obtained.

### First Embodiment

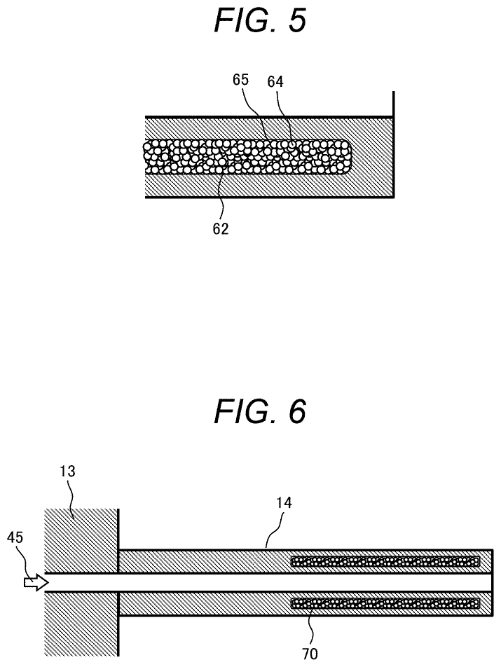

A structure and a manufacturing method of the fuel nozzle 14 according to the first embodiment of the present invention will be described with reference to FIG. 4 and FIG. 5. FIG. 4 is a sectional diagram illustrating one example of the fuel nozzle 14 of the first embodiment and is an enlarged diagram illustrating one example of a part 50 of the burner 17 which is illustrated in FIG. 2.

A fuel flow path 60 that the fuel 45 flows is formed in the center of the fuel nozzle 14. Streams of the fuel 45 which is distributed by the fuel nozzle plate 13 pass through the respective fuel nozzles 14 and are injected from leading ends 61 of the respective fuel nozzles 14.

The fuel nozzle 14 according to the first embodiment has a structure in which a region 62 on which the non-sintered metal powders are present is formed between the fuel flow path 60 and an outer circumferential face of the fuel nozzle 14. It is possible to manufacture this structure by leaving the metal powders on a part of the region 62 in a non-sintered state without being irradiated with laser in a process of manufacturing the fuel nozzle 14 by the 3D additive manufacturing. In general, one material is used in the 3D additive manufacturing and therefore the material quality of the non-sintered metal powders which are left in the component in the course of molding becomes the same as the material quality of the fuel nozzle 14.

FIG. 5 is an enlarged diagram illustrating one example of a region 63 in FIG. 4. Many non-sintered metal powders 64 are present on the region 62 and the metal powders 64 move (vibrate) in a case where the fuel nozzle 14 vibrates. The non-sintered metal powders 64 come into contact with one another in the course of movement and friction force generates. Thereby, such an effect that vibrational energy of the fuel nozzle 14 is dissipated and the vibration is damped is produced. In addition, the frictional force also generates between the non-sintered metal powders 64 and a wall face 65 of the region 62 in which the non-sintered metal powders 64 are encapsulated and thereby the effect that the vibration is damped is produced.

As described above, the fuel nozzle 14 of the gas turbine combustor in the first embodiment has the first region on which the metal powders are sintered and the second region (the region 62) which is surrounded by the first region and on which the metal powders are not sintered.

In addition, the fuel nozzle 14 has the second region (the region 62) between the fuel flow path 60 which is disposed ranging from the root to the leading end of the fuel nozzle 14 and the outer circumferential face of the fuel nozzle 14.

Thereby, it becomes possible to realize the gas turbine combustor which includes the fuel nozzle 14 which is high in damping performance against the vibration stress caused by the unstable combustion, in the gas turbine combustor which includes the fuel nozzle which is molded by the 3D additive manufacturing.

### Second Embodiment

A structure and a manufacturing method of the fuel nozzle 14 according to the second embodiment of the present invention will be described with reference to FIG. 6. FIG. 6 is a sectional diagram illustrating one example of the fuel nozzle 14 according to the second embodiment and is an enlarged diagram of the part 50 of the burner 17 which is illustrated in FIG. 2.

There are cases where the material strength of the section of the fuel nozzle 14 which contains the non-sintered metal powders is reduced due to a reduction in section modulus and stress concentration. In a case where the stress on the root of the fuel nozzle 14 is high, it is necessary to separate a metal powder non-sintered region from the root.

Accordingly, in the second embodiment, it becomes possible to damp the vibration with no reduction of the strength of the root by disposing a metal powder non-sintered region 70 on a part (a region) other than the root of the fuel nozzle 14 as illustrated in FIG. 6.

That is, the fuel nozzle 14 in the second embodiment has the second region (the metal powder non-sintered region 70) between the fuel flow path 60 except the root thereof and the outer circumferential face thereof.

### Third Embodiment

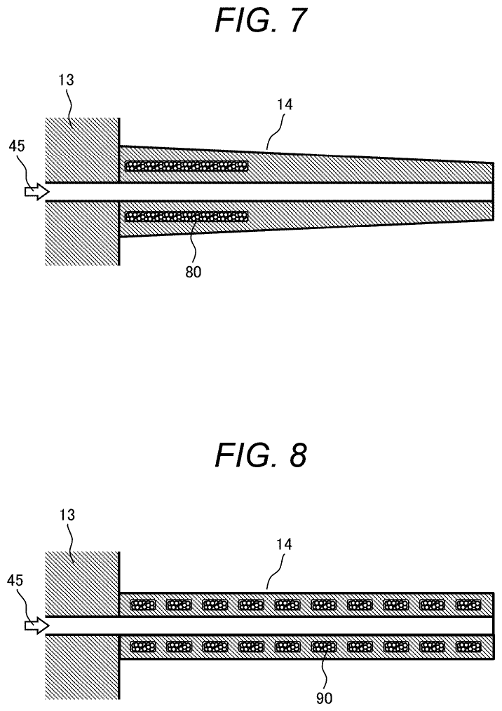

A structure and a manufacturing method of the fuel nozzle 14 according to the third embodiment of the present invention will be described with reference to FIG. 7. FIG. 7 is a sectional diagram illustrating one example of the fuel nozzle 14 according to the third embodiment and is an enlarged diagram of the part 50 of the burner 17 which is illustrated in FIG. 2.

In the fuel nozzle 14 which is tapered as illustrated in FIG. 7, there are cases where a space in which the metal powder non-sintered region is to be disposed is not present on the leading end side.

Accordingly, in the third embodiment, it becomes possible to leave the non-sintered metal powders even in the tapered fuel nozzle 14 and then to damp the vibration by disposing a metal powder non-sintered region 80 on the root side of the fuel nozzle 14 as illustrated in FIG. 7.

That is, the fuel nozzle 14 according to the third embodiment has the second region (the metal powder non-sintered region 80) between the fuel flow path 60 on the root side thereof and the outer circumferential face thereof and does not have the second region (the metal powder non-sintered region 80) between the fuel flow path 60 except the root thereof and the outer circumferential face thereof.

### Fourth Embodiment

A structure and a manufacturing method of the fuel nozzle 14 according to the fourth embodiment of the present invention will be described with reference to FIG. 8. FIG. 8 is a sectional diagram illustrating one example of the fuel nozzle 14 according to the fourth embodiment and is an enlarged diagram of the part 50 of the burner 17 in FIG. 2.

In a case where the metal powder non-sintered region 62 which continuously extends ranging from the root to the leading end of the fuel nozzle 14 is disposed as in the first embodiment (FIG. 4), there are cases where rigidity of the fuel nozzle 14 is reduced. In a case where it is wished to increase the rigidity for the convenience of strength design and detuning design, it becomes possible to increase the rigidity by dividing the metal powder non-sintered region 62 which continuously extends as illustrated in FIG. 4 into a plurality of metal powder non-sintered regions 90 as illustrated in FIG. 8.

Incidentally, although FIG. 8 illustrates one example that the metal powder non-sintered region 62 is disposed in a state of dividing into the plurality of powder non-sintered regions 90 in the axial direction of the fuel nozzle 14, it is also possible to increase the rigidity similarly by dividing the metal powder non-sintered region 62 into a plurality of regions in the circumferential direction of the fuel nozzle 14.

That is, in the fuel nozzle 14 according to the fourth embodiment, the second region (the metal powder non-sintered region 90) is divided into the plurality of regions in the axial direction or the circumferential direction of the fuel nozzle 14.

### Fifth Embodiment

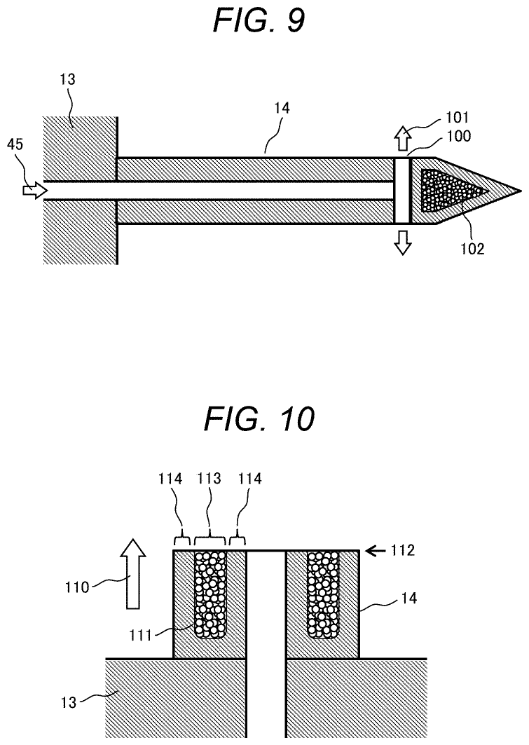

A structure and a manufacturing method of the fuel nozzle 14 according to the fifth embodiment of the present invention will be described with reference to FIG. 9. FIG. 9 is a sectional diagram illustrating one example of the fuel nozzle 14 according to the fifth embodiment and is an enlarged diagram of the part 50 of the burner 17 which is illustrated in FIG. 2.

The fuel nozzle 14 according to the fifth embodiment has a structure that fuel 101 is injected from fuel injection holes 100 in side faces as illustrated in FIG. 9. In the fuel nozzle 14 of this type, it is possible to dispose a metal powder non-sintered region 102 on the leading-end side ahead of the side-face fuel injection holes 100 and thereby to damp the vibration.

That is, the fuel nozzle 14 according to the fifth embodiment has the fuel injection holes 100 in the side faces and has the second region (the metal powder non-sintered region 102) on the leading end side ahead of the fuel injection holes 100.

### Sixth Embodiment

A fuel nozzle manufacturing method according to the sixth embodiment will be described with reference to FIG. 10. FIG. 10 illustrates one example of an interim process of manufacturing the fuel nozzle 14 by the 3D additive manufacturing.

Molding is performed in a direction 110 starting from the fuel nozzle plate 13 side and FIG. 10 illustrates a moment that a face 112 is being molded.

In a process of molding a metal powder non-sintered region 111, it becomes possible to leave a metal powder non-sintered region 111 by not irradiating a part 113 which is to be brought into a metal powder non-sintered state with laser and irradiating only a part 114 which is to be brought into a metal powder sintered state with laser on the face 112 which is being molded.

As described above, the fuel nozzle manufacturing method according to the sixth embodiment is the method of manufacturing the fuel nozzle 14 by the 3D additive manufacturing which includes the steps of (a) irradiating the first region (the part 114 to be brought into the metal powder sintered state) of the molding face (the face 112 which is being molded) by the metal 3D additive manufacturing with laser so as to sinter the metal powders on the first region and (b) leaving non-sintered metal powders on the second region (the part 113 to be brought into the metal powder non-sintered state) which is surrounded by the first region (the part 114 to be brought into the metal powder sintered state) of the molding face (the face 112 which is being molded) with no laser irradiation.

Incidentally, the present invention is not limited to the abovementioned embodiments, and various modified example are included. For example, the abovementioned embodiments are described in detail for supporting better understanding of the present invention, and the present invention is not necessarily limited to the embodiment which includes all the configurations which are described above. In addition, it is also possible to replace one configuration of one embodiment with one configuration of another embodiment. In addition, it is also possible to add one configuration of another embodiment to one configuration of one embodiment. In addition, it is possible to add/delete/replace one configuration of each embodiment to/from/with another configuration of each embodiment.

### REFERENCE SIGNS LIST

1: gas turbine plant
2: air
3: compressor
4: compressed air
5: fuel
6: combustion gas
7: combustor
8: gas turbine
9: generator
10: end flange
11: external cylinder
12: perforated plate 12
13: fuel nozzle plate
14: fuel nozzle
15: liner
16: flow path (which is formed between external cylinder
11 and liner 15)
17: burner
18: cooling air
19: fuel feed pipe
20: nozzle holes
21: air-fuel mixture
22: combustion chamber
23: flame
30: upstream-side end (of fuel nozzle 14)
40: central axes (of perforated plate 12 and fuel nozzle plate 13)
45: fuel (that flows in fuel nozzle 14)
50: part of burner 17
52: leading end (of fuel nozzle 14)
60: fuel flow path (of fuel nozzle 14)
61: leading end (of fuel nozzle 14)
62: (metal powder non-sintered) region
63: region (of leading end of fuel nozzle 14)
64: non-sintered metal powders
65: wall face (of space (region 62) in which the non-sintered metal powders are encapsulated)
70: (metal powder non-sintered) region
80: (metal powder non-sintered) region
90: (metal powder non-sintered) region
100: fuel injection hole
101: fuel (injected from fuel injection holes 100 in side faces of fuel nozzle 14)
102: (metal powder non-sintered) region
110: direction of manufacturing (additive direction)
111: (metal powder non-sintered) region
112: face (which is being molded)
113: part (of molding face which is to be brought into metal powder non-sintered state)
114: part (of molding face which is to be brought into metal powder sintered state)

What is claimed is:

1. A gas turbine combustor comprising a fuel nozzle which is molded by 3D additive manufacturing,
wherein the fuel nozzle has a first region on which metal powders are sintered, and
a second region which is surrounded by the first region and on which the metal powders are not sintered.

2. The gas turbine combustor according to claim 1, wherein the fuel noddle has the second region between a fuel flow path which is disposed ranging from a root of the fuel nozzle to a leading end thereof and an outer circumferential face of the fuel nozzle.

3. The gas turbine combustor according to claim 2, wherein the fuel nozzle has the second region between the fuel flow path except the root of the fuel nozzle and the outer circumferential face thereof.

4. The gas turbine combustor according to claim 2,
wherein the fuel nozzle has the second region between the fuel flow path which includes the root of the fuel nozzle and the outer circumferential face thereof, and
the fuel nozzle does not have the second region between the fuel flow path except the root of the fuel nozzle and the outer circumferential face thereof.

5. The gas turbine combustor according to claim 2, wherein the second region is divided into a plurality of parts in an axial direction or a circumferential direction of the fuel nozzle.

6. The gas turbine combustor according to claim 1,
wherein the fuel nozzle has fuel injection holes in side faces, and
the fuel nozzle has the second region on the leading end side ahead of the fuel injection holes.

7. A method of manufacturing a fuel nozzle by metal 3D additive manufacturing, comprising the steps of:
(a) irradiating a first region of a face which is molded by the metal 3D additive manufacturing with laser and sintering metal powders onto the first region; and
(b) leaving non-sintered metal powders on a second region which is surrounded by the first region of the molded face with no irradiation of the second region with laser.

8. The method of manufacturing the fuel nozzle according to claim 7, wherein the second region is formed between a fuel flow path which is disposed ranging from a root of the fuel nozzle to a leading end thereof and an outer circumferential face of the fuel nozzle.

9. The method of manufacturing the fuel nozzle according to claim 8, wherein the second region is formed between the fuel flow path except the root of the fuel nozzle and the outer circumferential face thereof.

10. The method of manufacturing the fuel nozzle according to claim 8,
wherein the second region is formed between the fuel flow path which includes the root of the fuel nozzle and the outer circumferential face thereof, and
the second region is not formed between the fuel flow path except the root of the fuel nozzle and the outer circumferential face thereof.

11. The method of manufacturing the fuel nozzle according to claim 8, wherein the second region is formed by being divided into a plurality of parts in an axial direction or a circumferential direction of the fuel nozzle.

12. The method of manufacturing the fuel nozzle according to claim 7,
wherein fuel injection holes are formed in side faces of the fuel nozzle, and
the second region is formed on the leading end side ahead of the fuel injection holes.
